(19) United States
(12) Patent Application Publication
(10) Pub. No.: US 2024/0013579 A1
(43) Pub. Date: Jan. 11, 2024

(54) Attendance Monitoring and Notification System

(71) Applicant: Harold Artemus, Matthews, NC (US)

(72) Inventor: Harold Artemus, Matthews, NC (US)

(21) Appl. No.: 17/859,150

(22) Filed: Jul. 7, 2022

(51) Int. Cl. G07C 1/10; G06Q 50/20

(52) U.S. Cl. CPC G07C 1/10; G06Q 50/20

(57) ABSTRACT

The present invention relates to a system and method for attendance monitoring of students or individuals. The system includes a plurality of attendance monitoring devices placed at doors of classrooms, buses, recreational areas and the like. The attendance monitoring devices have a swipe slot or scanner in which students swipe or scan their ID card. An alert including student ID, student name, in-time or out-time information, a video of the student swiping the card and location of the attendance monitoring device is received on an attendance application installed in a remote electronic device or alternatively received on a key fob. The alert provides real-time information of the location of the student to parents and caretakers during a school day. A central hub stores student information, parent information and attendance device information.

### FIELD OF THE INVENTION

The present invention relates generally to the field of attendance monitoring systems. More specifically, the present invention relates to a student attendance monitoring and notification system and method to track the school attendance of a student electronically and provide live updates to parents and guardians throughout the day. The student attendance monitoring and notification system comprises of a module featuring a digital clock-in/clock-out box, that includes a touchscreen display and fingerprint recognition feature, and allows a child to swipe his or her identity cards on the module. Once the identity card is swiped-in and/or swiped-out in the module, the module receives corresponding information and detects the time of swipe-in and swipe-out of the identity card, and transmits the alerts/notifications to the parents/guardians/teachers of the child in real-time. Accordingly, the present disclosure makes specific reference thereto. Nonetheless, it is to be appreciated that aspects of the present invention are also equally applicable to other like applications, devices and methods of manufacture.

### BACKGROUND

By way of background, for many educational and other institutions such as schools, colleges and more, it can be difficult to monitor and track the presence and/or absence of each student in each class, activity, event or other scenarios. Usually, a manual attendance register is maintained to monitor the presence and/or absence of the students studying at any educational institution. However, maintaining the manual student attendance register is a time-consuming and tedious chore. Since the heretofore known student attendance registers are maintained manually, there are chances of discrepancies in maintaining the attendance register. Also, the manual student attendance registers are not accessible by the parents and guardians in real-time. Currently, parents cannot track their children in real-time.

In case any student does not show up for school or the school bus, there can be many reasons behind it. For example, the student intentionally leaves or skips class, the child gets abducted on the way to or from school or more. In such scenarios, although the absence of the students will be marked in the manual attendance register, the parents remain unaware of the presence/absence of children from classes/buses/events.

There can be a number of events occurring throughout the school day that may affect a student. During most of the day, parents/guardians do not have an effective means of tracking their child and/receiving alerts of their child's location in various events at school. Additionally, in case of an emergency situation such as school shooting, parents are often distraught when they cannot locate and track their child immediately. In such scenarios, parents and guardians of children would be relieved to know when their child arrives at school, when they reach his or her classes, and/or when he or she departs for the bus, etc.

Therefore, there exists a long felt need in the art for a student attendance monitoring system that enables teachers, parents and guardians to track the presence and/or absence of students in classes, buses, events or the like. There is also a long felt need in the art for a student attendance monitoring system that ensures the parents are aware of the activities of their children, and are able to locate their children throughout their day at schools or other educational institutions. Additionally, there is a long felt need in the art for a student monitoring system that enables the parents to locate their child in case of any emergency situations such as a school shooting or the like. Moreover, there is a long felt need in the art for a student attendance tracking system that is not manual and is not a time-consuming and tedious process. Further, there is a long felt need in the art for a student attendance tracking system that ensures the child's attendance is readily available to the parents in real-time, and accurately tracks the child's movements. Furthermore, there is a long felt need in the art for a student attendance monitoring and notification system that provides effective tracking and monitoring of children, and ensures peace of mind for parents and guardians. Finally, there is a long felt need in the art for a student monitoring and notification system that allows users to track the whereabouts of a student in the event that he or she is not where he or she is supposed to be at any given time.

The subject matter disclosed and claimed herein, in one potential embodiment thereof, comprises an attendance monitoring system that is configured to provide real-time alerts for parents and guardians to track the location of their child during a school day. The system comprises a plurality of attendance modules, a central hub connected to the plurality of attendance modules and a software application configured to receive real-time alerts. Each attendance module of the attendance monitoring system includes a fingerprint sensor, a swipe slot or scanner for receiving or scanning an ID card of a student, a camera for recording video of a student while swiping the card in a swipe slot or past a scanner, a built-in clock to timestamp in-time and out-time of the student during swiping of the card, a touchscreen display to display student information corresponding to the detected student ID and in-time and out-time. The central hub is configured for receiving alerts including student information, in-time, out-time and location from the plurality of attendance modules, and transmitting the received alerts to at least one of an electronic device with the installed software application and a key fob.

In this manner, the novel student monitoring and notification system of the present invention accomplishes all of the forgoing objectives, and provides a relatively effective and convenient solution to maintain attendance of students in any educational institution. The student monitoring and notification system of the present invention ensures that parents are aware of the whereabouts of their children in real-time, and enables them to locate their children in case of any emergency situations such as a school shooting, etc. The student monitoring and notification system provides an efficient attendance and tracking method that eliminates any risk of discrepancies, and does not require any effort of teachers to maintain or update attendance of their students.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one potential embodiment thereof, comprises an attendance monitoring system. The attendance monitoring system is configured to provide real-time alerts allowing parents and guardians to track the location of their child before, during and after a school day. The system further comprises: a plurality of attendance modules; a central hub connected to the plurality of attendance modules and a software application configured to receive real-time alerts; each attendance module of the plurality of attendance modules includes a fingerprint sensor, a swipe slot or scanner for receiving an ID card of a student, a built-in clock to timestamp in-time and out-time of the student during swiping of the card, a touchscreen display to display student information corresponding to the detected student ID and in-time and out-time; the central hub is configured for receiving alerts including student information, in-time, out-time and location from the plurality of attendance modules; and, transmitting the received alerts to at least one of an electronic device with the installed software application and a key fob.

In yet another embodiment of the present invention, a student ID is registered in the attendance monitoring system. The system includes a student database for storing student IDs, student names and fingerprints; a parent profile database for storing parent names and their contact details and an attendance module database for storing attendance module location information.

In yet another embodiment of the present invention, parent contact sources corresponding to a student ID are used for transmitting alerts for their child/student. The alerts are transmitted directly to the parents by the attendance modules or through the central hub.

In yet a further embodiment of the present invention, a method for tracking and monitoring the location of a child throughout a school day by parents or caretakers is described. The method includes: an attendance module receiving student ID information through swiping of an ID card; timestamping the in-time or out-time using a built-in clock; displaying student information, location of the attendance module and in-time and out-time; and a software application installed in a remote electronic device for receiving a real-time alert displaying student's name and ID, location of the attendance module, in-time and out-time and a video of the student swiping on the attendance module. The alert can be received directly from the attendance module or through a central hub.

In yet another embodiment the method further comprises retrieving a student name corresponding to a student ID from a student profile database and retrieving parents' contact information corresponding to the student ID for transmitting the alert message.

In yet a further embodiment of the present invention, the alert is transmitted to a touchscreen key fob device. The key fob is registered for receiving alerts, and a parent profile is created on the key fob.

In yet another embodiment of the present invention, a student registers a fingerprint on an attendance module wherein the fingerprint can be used on any attendance module of the system, and a parent creates a profile on the software application to receive real-time alerts.

In yet another embodiment of the present invention, the attendance module is configured to transmit location information, bus number, and/or student ID in an alert. The attendance module can be voice-operated by an administrator such as a teacher.

The attendance monitoring system further comprises an attendance application stored on the plurality of user devices wherein the attendance application is configured to receive real-time video alerts in response to an ID swipe or fingerprint scan of a student on an attendance module.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic diagram of one potential embodiment of an attendance monitoring and notification system of the present invention in accordance with the disclosed architecture;

FIG. 2 illustrates a perspective view of one potential embodiment showing an attendance module used in the present invention in accordance with the disclosed architecture;

FIG. 3 illustrates a block diagram of one potential embodiment showing components of the attendance module of the present invention in accordance with the disclosed architecture;

FIG. 4 illustrates a perspective view of one potential embodiment showing databases coupled or integrated to the central hub of the attendance monitoring system of the present invention in accordance with the disclosed architecture;

FIG. 5 illustrates a flow diagram of one potential embodiment showing exemplary steps of an operation of the attendance module of the present invention for generating alerts in accordance with the disclosed architecture;

FIG. 6 illustrates a flow diagram of one potential embodiment showing steps performed by parents or caretakers for receiving real time alerts at the mobile device or a key fob using the attendance monitoring system of the present invention in accordance with the disclosed architecture;

FIG. 7 illustrates a perspective view of a student swiping an ID card on the attendance module of the present invention in accordance with the disclosed architecture;

FIG. 8 illustrates an exemplary notification alert shown on a software application of the attendance monitoring system of the present invention in accordance with the disclosed architecture;

FIG. 9 illustrates an exemplary notification alert shown on a key fob possessed by a parent for receiving alerts from the attendance monitoring system of the present invention in accordance with the disclosed architecture; and

FIG. 10 illustrates exemplary electronic components in one potential embodiment upon which the computer implemented application of the present invention can be implemented in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a student attendance monitoring system that enables the teachers, parents and guardians to track the presence and/or absence of students in classes, buses, events or the like. There is also a long felt need in the art for a student attendance monitoring system that ensures the parents are aware of the activities of their children, and are able to locate their children throughout the day at schools or other educational institutions. Additionally, there is a long felt need in the art for a student monitoring system that enables the parents to locate their child in case of any emergency situations such as a school shooting or the like. Moreover, there is a long felt need in the art for a student attendance tracking system that is not manual, and is not a time-consuming and tedious process. Further, there is a long felt need in the art for a student attendance tracking system that ensures the child's attendance is readily available to the parents in real-time and accurately tracks the child's movements. Furthermore, there is a long felt need in the art for a student attendance monitoring and notification system that provides an effective tracking and monitoring of children, and ensures peace of mind for parents/guardians. Finally, there is a long felt need in the art for a student monitoring and notification system that allows users to track the whereabouts of a student in the event that the student is not where he or she is supposed to be at any given time.

The present invention, in one potential embodiment, includes a novel method for tracking and monitoring locations of a child throughout a school day by parents or caretakers. The method is implemented using an attendance module that receives student ID information through the swiping of an ID card, and that timestamps the in-time or out-time using a built-in clock. The module displays student information, location of the attendance module and in-time and out-time. The module includes a transmitter that transmits a real-time alert to a software application installed in an electronic device that can display a student's name and ID, location of the attendance module, in-time and out-time and a video of the student swiping on the attendance module. The alert can be received directly from the attendance module or through a central hub. The method ensures the parents and caretakers can easily track and monitor their children's whereabouts throughout the day at school or other educational institutions.

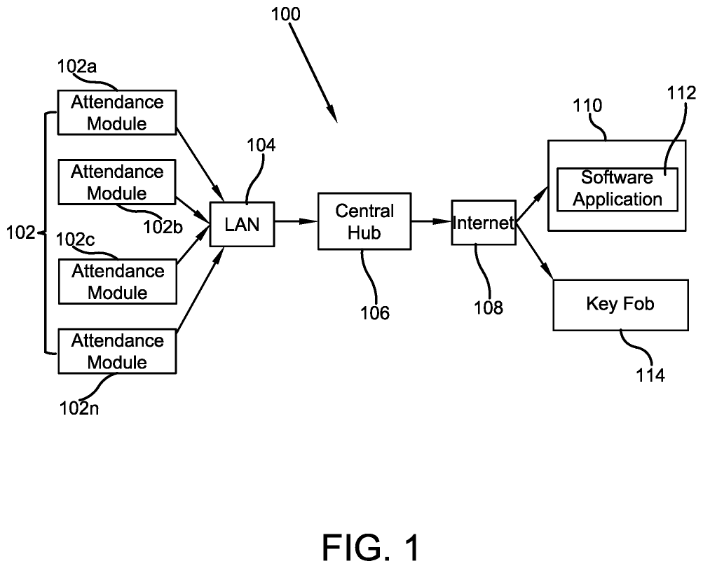

Referring initially to the drawings, FIG. 1 illustrates a schematic diagram of an attendance monitoring and notification system of the present invention in accordance with the disclosed architecture. The attendance monitoring and notification system 100 is designed to track school attendance of students electronically, and provides live (i.e. real-time) updates to parents and guardians throughout the day. The system 100 includes a plurality of attendance modules or attendance monitoring devices 102 placed at various entry points of a building, such as a school building. The plurality of attendance modules can be shown as 102a, 102b, 102c . . . 102n, and each attendance module can be mounted at the door of a classroom, school bus or any recreational area of the school to capture the presence of a student at all possible entry points. For description purposes, the attendance module will be referred to as 102 further in the specification. Each attendance module 102 can be mounted at the entrances or exits of an educational institution. Similarly, the attendance monitoring device 102 can also be placed at the entrance of the classrooms, at the door of the school buses or at a place on the school premises that is easily visible to students.

Each attendance monitoring device 102 can generate an alert that can be transmitted to parents, teachers, guardians or other users, wherein each alert includes a location of the attendance module 102 in which the students swipe-in or swipe-out using their identity cards. Further, information related to in-time, out-time or bus number can also be included in the alert transmitted to the parents, teachers, guardians or other users.

Each attendance module 102 can be connected to a central hub 106 (placed locally at the education institution or a cloud server) through a local network 104. The local network 104 can use the internet to transmit the attendance information to the central hub 106. The central hub 106 transmits real-time attendance information captured by the attendance modules 102 of a student during a school day to a remote electronic device 110 using a public network 108 such as the internet. The remote electronic device 110 includes a computer-implemented software application or attendance application 112 that is configured to connect to receive real time updates from the central hub 106. A parent or a guardian creates a profile in the software application 112, and associates their profile with a profile of a student to receive real-time updates about the student. The hub 106 also transmits information related to an emergency situation such as a school shooting, school fire or any other such type emergency situation. The hub 106 can also transmit information related to the holidays in the school, such as early dismissal or any other type of holiday. In addition to transmitting real-time information to the attendance application 112, the hub 106 also transmits the information to a key fob device 114 provided to parents by an educational institution implementing the attendance monitoring and notification system 100 of the present invention.

The attendance monitoring device 102 includes a swiping slot in which a student swipes an identity card after authenticating through a registered fingerprint. A new student when enrolled in the educational institution, can register his or her fingerprints, which are then used for authentication to swipe the identity card. A real-time notification comprising a timestamp and a location of the attendance module 102 in which the attendance card is swiped, can be transmitted to the parents, thereby allowing the parents to be aware of the location and movements of the student throughout the day. A student can swipe the identity card on an attendance module 102 while entering a bus, classroom or any other area that has the attendance module 102 in order to allow the parents to receive real-time notifications.

It should be noted that an educational institution, its students and the parents of the students have to be enrolled in the system 100 to track and receive notifications. The parents, guardians and caretakers can track the location of their child during the entire day at school or at other educational institutions. The system 100 allows both parents and educational entities to track the whereabouts of a student in the event that they are not where they are supposed to be at any given time.

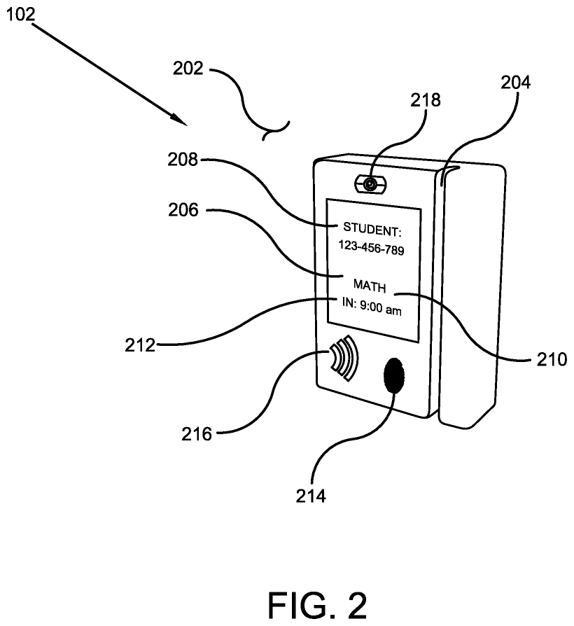

FIG. 2 illustrates a perspective view showing one potential embodiment of an attendance module used in the present invention in accordance with the disclosed architecture. The attendance module 102 of the present invention is designed to capture attendance information of students, and transmit the captured information to a central hub to notify the parents, guardians or caretakers of students who attend an educational institution such as a school. It should be noted that in one embodiment, the attendance module 102 can transmit the real-time attendance information directly to parents or caretakers without going through the central hub.

The attendance monitoring device 102 can be mounted on a classroom wall 202 near a door allowing easy access of the module 102 to the students. The attendance module 102 includes a swipe slot or scanner 204 (i.e. an ID reader) where each student swipes or scans his or her ID card. The student ID card can include an ID tag such as an RFID tag, in which identification information corresponding to each student is stored. The swipe slot or scanner 204 includes a tag reader that reads the stored ID information of the tag. A student ID and associated name of the student is determined when the ID card is swiped, thereby notifying the associated/connected parents, guardians, or caretakers about the student swipe time and location information.

The attendance module 102 includes a touchscreen display 206 that displays the information identified by the student ID card. The touchscreen display 206 displays information such as Student ID 208, location 210 such as classroom name and floor number, in-time 212 and out-time (not shown) for each student. The name of the student can also be optionally displayed on the touchscreen display 206. The module 102 includes a fingerprint scanner 214 that can be used in place or in conjunction with the swiping of the student ID tag. In situations where the student fingerprint and/or student ID is not registered in the system of the present invention, the module 102 generates an error. The attendance monitoring device 102 includes a microphone 216 that enables users, such as teachers of the classroom, to activate the module 102 using voice commands. A high definition (HD) video camera 218 captures video of the student swiping the student ID tag and the captured video can be included in the alert.

It should be appreciated that parents, caretakers and/or guardians can receive real-time video alerts of the students when they are entering or leaving the classroom. The attendance module 102 can also be mounted on the entrance of the school bus, so that parents can track the location of their children when they are entering or exiting the school bus. The attendance module 102 of the present invention allows parents, caretakers and/or guardians to track the whereabouts of a student, in the event that he or she is not in the proper area at any given time. The attendance module 102 captures both the in-time and the out-time for providing real-time information to the parents, care-takers and teachers.

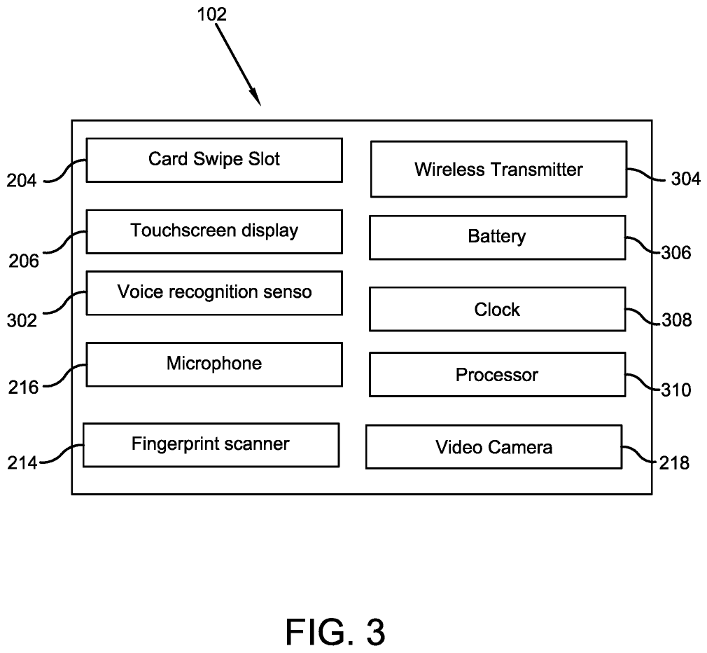

FIG. 3 illustrates a block diagram showing the essential components of the attendance module of the present invention in accordance with the disclosed architecture. As shown in FIG. 3, the attendance monitoring device 102 has a card swipe slot or scanner 204 that automatically reads the identification information stored in a student's ID tag when the student swipes his or her ID card. The card swipe slot or scanner 204 reads the tag information when the student swipes his or her ID card at the time when the student is entering or leaving a classroom, school or bus. The module 102 includes a touchscreen display 206 that displays information such as student ID, location of the student ID swipe, in-time and out-time for each student. The module 102 includes a voice recognition sensor 302 that recognizes the voice commands of a user, and activates the module 102. The fingerprint scanner 214 receives a student's fingerprint and can be used in place or in conjunction with the swipe area 204. An internal battery 306 provides power for the functioning of the attendance module 102.

An integrated wireless transmitter 304 establishes a wireless channel for the module 102 to send the real-time alerts to a central hub and/or remote electronic devices held by the parents and/or caretakers. The module 102 includes a built-in clock 308 that can be used for timestamping the in-time and out-time when a fingerprint or a swipe is performed on the attendance module 102. The in-time is detected when a student enters the classroom, bus or school, and an out-time is determined subsequent to an in-time. A processor 310 can also perform some rudimentary processing and generates alerts and other information to be wirelessly transmitted from the module 102. A HD video camera 218 captures video of the student swiping the student ID tag and the captured video is included in the alert.

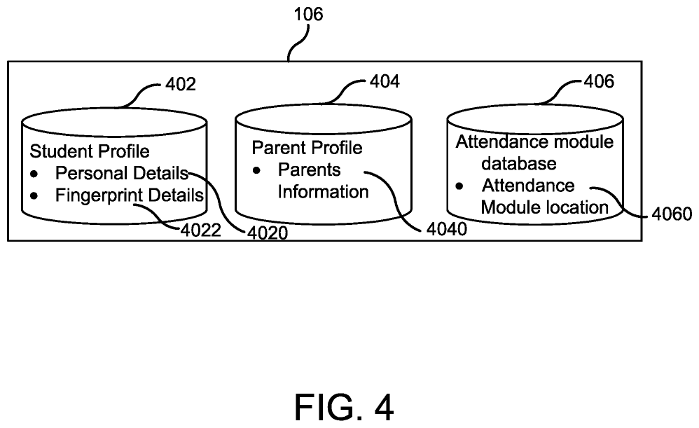

FIG. 4 illustrates a perspective view showing databases coupled or integrated to the central hub of an attendance monitoring system of the present invention in accordance with the disclosed architecture. The central hub 106 includes a plurality of databases containing information pertaining to the students, parents, and the attendance modules. It should be appreciated that the databases can be coupled to the attendance modules as well, enabling an attendance module to directly transmit the real time alerts to the parents and caretakers. The central hub 106 includes a student profile database 402, a parent profile database 404, and an attendance module database 406.

The student profile database 402 can store personal details 4020 such as student ID and student name. The student profile database 402 also stores fingerprint information 4022 that was previously registered during registration of the student. The parent profile database 404 stores information associated with parents' details 4040, such as parents' names, contact details and other such types of information. Also, it should be noted that there is a mapping between the student ID and the parent contact information, thereby allowing an authorized parent or caretaker to receive information related to the associated student.

The attendance module database 406 stores attendance module location 4060 information. Location information such as a particular classroom named as Math, English or the like along with the floor information can be stored in the database 406. The attendance module location 306 also stores information related to a bus number on which the attendance module is mounted.

When an attendance alert is generated by an attendance module, the parents' information 4040 with respect to each student is retrieved from the database 404 and alerts, or notifications are sent to the parents or caretakers based on the information stored in the parent profile database 404. The alerts can have the information related to the attendance module location 4060 retrieved from the attendance module database 406.

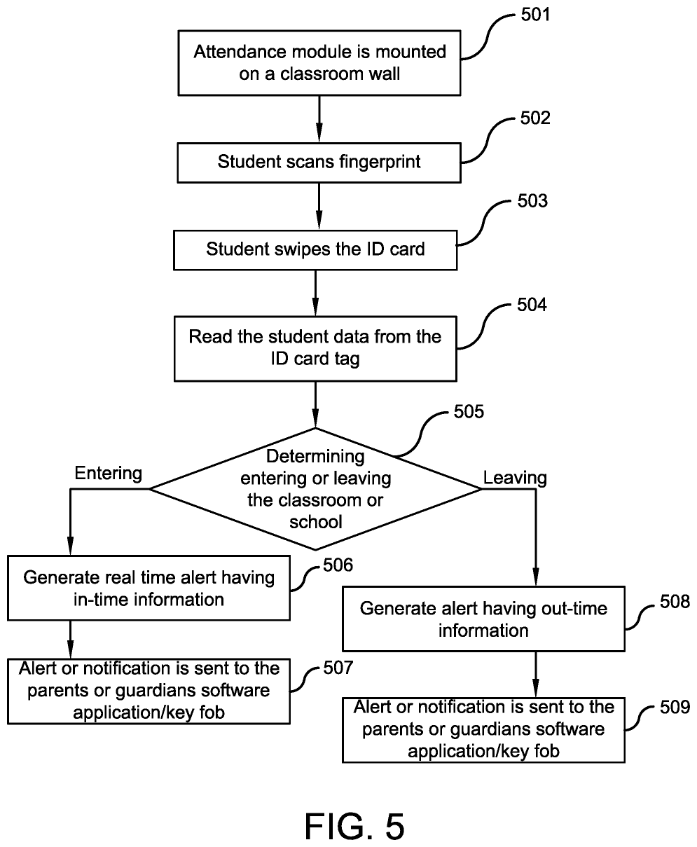

FIG. 5 illustrates a flow diagram showing exemplary steps of an operation of the attendance module of the present invention for generating alerts in accordance with the disclosed architecture. As shown in FIG. 5, initially, the attendance module is mounted at one or more desired places, such as on a classroom wall, where the student's entry and exit time needs to be tracked and forwarded to the parents. The attendance module can also be mounted at the entrance or exit of the educational institution. Further, the attendance module can be placed on multiple entrances or multiple exits of the educational institution (Block 501). A student, when entering in the classroom, can scan his/her fingerprint by placing a finger on the fingerprint scanner integrated in the attendance module (Block 502). Then, the student swipes an ID card in which identification information corresponding to the student is stored (Block 503).

It should be noted that the fingerprint and the swiping can be used in conjunction with one another, or any one of the two can also be used for attendance monitoring. Then, the attendance module reads the student data from the ID card tag and identifies the identification information related to the student stored in the student's ID tag when the student swipes the ID card (Block 504). Thereafter, it is determined if the student is entering or leaving the classroom or school building (Block 505). If it is determined that the student is entering the classroom, then a real-time alert having in-time information is generated (Block 506). The information or the alert or notification with the in-time information is sent to the parents or guardians software application or key fob, either directly or through a central hub (Block 507).

Further, in Block 505, if it is determined that the student is leaving the classroom or school building, then a real-time alert having out-time information can be generated (Block 508). Accordingly, an alert or notification with the out-time information can be sent to the parents' or guardians' software application or key fob, either directly or through a central hub (Block 509). In addition to the alerts, the captured information can be shown on the touchscreen display of the attendance module to ensure students that the information is correctly captured by the module.

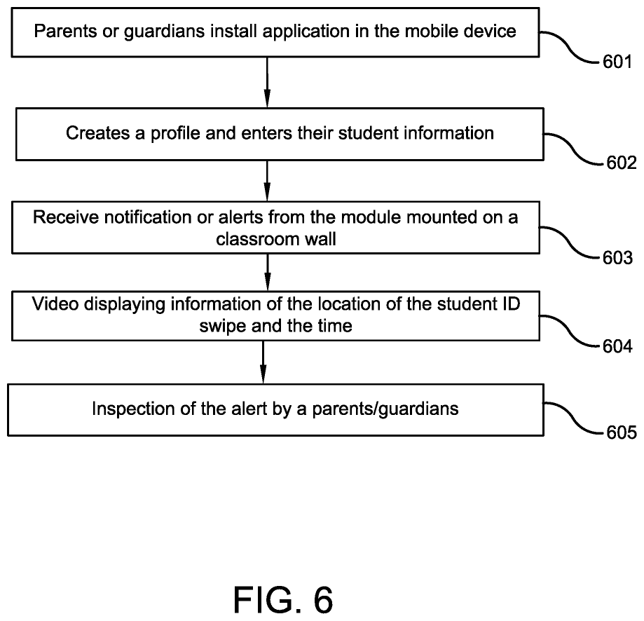

FIG. 6 illustrates a flow diagram showing steps performed by parents or caretakers for receiving real-time alerts at the mobile device or a key fob using an attendance monitoring system of the present invention in accordance with the disclosed architecture. As shown in FIG. 6, for receiving an alert or notification at the mobile device, parents or guardians can install a computer-implemented software application in a remote electronic device (Block 601). Then, the parent can create a profile, and add student information for which the attendance information would be received (Block 602). Thereafter, the software application starts receiving the notification or alerts from the attendance modules (Block 604). The alerts or notifications also include a video display that displays information of the location of the student ID swipe and the in-time or out-time of the classroom or building (Block 604). The alert can also show the information related to the bus number when the student enters or exits the bus. The received alerts can be seen and reviewed by the parents, caretakers and/or guardians (Block 605).

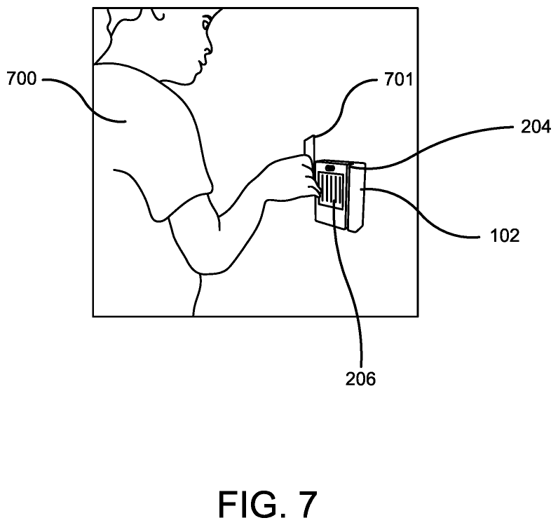

FIG. 7 illustrates a perspective view of one potential embodiment of a student swiping ID card on the attendance module of the present invention in accordance with the disclosed architecture. In use, a student 700 swipes the student ID card 701 in the card swipe slot 204 of the attendance module 102. The student ID card 701 can be a card type with a built-in ID chip for storing student information. The ID card 701 stores identification information corresponding to the associated student carrying the ID card, such as student ID. The ID card 701 includes a size and thickness that can be stored in a commercially available wallet or card holder, and is easy for students to carry and handle. As the student 700 swipes the ID card 701, the attendance module 102 identifies the identification information stored in the ID card and displays the information on the touchscreen display 206 of the module 102.

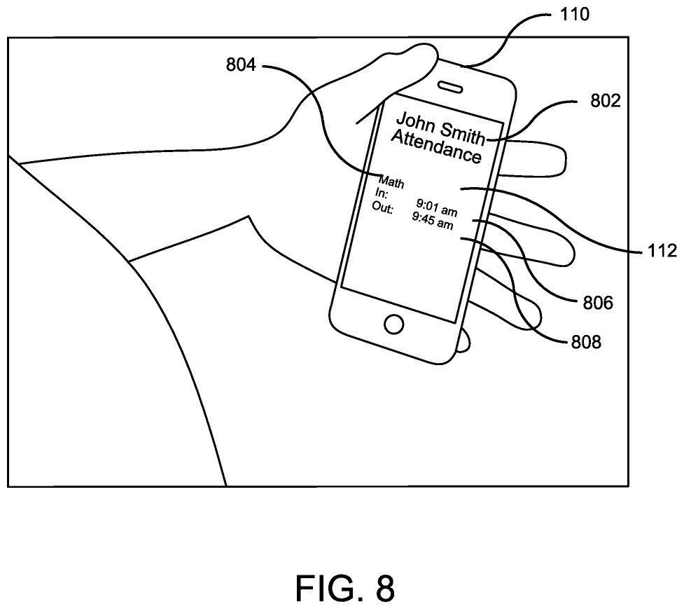

FIG. 8 illustrates an exemplary notification shown on software application of attendance monitoring system of the present invention in accordance with the disclosed architecture. As stated earlier, an electronic device 110 (i.e. a remote device) has an installed computer-implemented software application 112 that receives real-time school entry/exit information of a student and live updates throughout the day. The alerts received by the software application 112 on the electronic device 110 can display the student name 802, and location 804 of the student ID swipe, such as entering math class or entering the bus. The alert can also display in-time 806 and out-time 808, so that parents can track their child throughout the day. The in-time 806 and out-time 808 enable parents and guardians to track whether their student has attended the complete classroom session. Similar alerts can be shown or transmitted to a key fob which is registered to the system of the present invention.

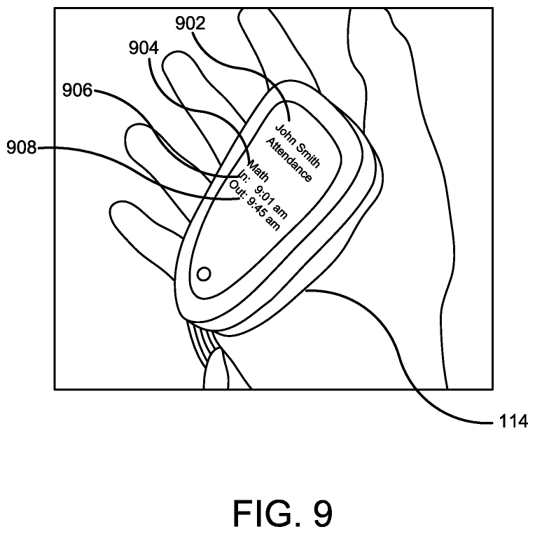

FIG. 9 illustrates an exemplary notification alert shown on a key fob possessed by a parent for receiving alerts from attendance monitoring systems of the present invention in accordance with the disclosed architecture. The key fob 114 receives real-time school attendance alerts of a student and live updates throughout the day. The alerts received by the key fob 114 displays the student's name 902, and location 904 of the student ID swipe, such as entering the math class or entering the bus. The alert can also display in-time 906 and out-time 908 so that parents can track their child throughout the day. The in-time 906 and out-time 908 enable parents and guardians to track whether their student has attended the complete classroom session.

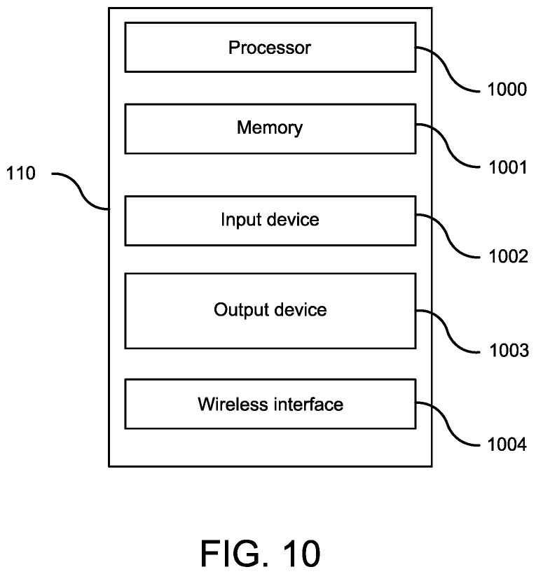

FIG. 10 illustrates an exemplary electronic device upon which the computer-implemented application of the present invention can be implemented in accordance with the disclosed architecture. The electronic device 110 includes several components, such as a processor 1000 configured to perform one or more functions described herein in accordance with the computer-implemented instructions. The electronic device 110 includes input device(s) 1002 such as a mouse, keyboard, touch input device, voice input device, etc., for entering data and information. The electronic device 110 also includes one or more output device(s) 1003 such as a monitor, presence-sensitive display or other display device. The electronic device 100 has memory 1001 used for storing programs (sequences of instructions) or data (e.g., program state information) on a temporary or permanent basis for use in the computer system. Memory 1001 may be configured for short-term storage of information as volatile memory, and therefore not retain stored contents if powered off. Examples of volatile memories include random access memories (RAM), dynamic random access memories (DRAM), static random access memories (SRAM) and other forms of volatile memories known in the art. The processor 1000, in combination with one or more of memory 1001, input device(s) 1002 and output device(s) 1003 can be utilized to provide parents with the ability to view alerts. The connection to a network can be provided by a wireless interface 1004, thereby enabling receipt of real time alerts.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “attendance monitoring and notification system”, “attendance module”, “student monitoring and notification system” and “system”, are interchangeable and refer to the attendance monitoring and notification system 100 of the present invention.

Notwithstanding the forgoing, the attendance module 102 of the attendance monitoring and notification system 100 of the present invention can be of any suitable size and configuration as is known in the art without affecting the overall concept of the invention, provided that it accomplishes the above-stated objectives. One of ordinary skill in the art will appreciate that the size, configuration, and material of the attendance module 102 of the attendance monitoring and notification system 100 as shown in the FIGS. are for illustrative purposes only, and that many other sizes and shapes of the attendance module 102 of the attendance monitoring and notification system 100 are well within the scope of the present disclosure. Although the dimensions of the attendance module 102 of the attendance monitoring and notification system 100 are important design parameters for user convenience, the attendance module 102 of the attendance monitoring and notification system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An attendance monitoring and notification system for tracking location of a plurality of individuals, the attendance monitoring and notification system comprising:
a plurality of attendance modules;
a central hub remotely connected to said plurality of attendance modules;
a software app to receive real time alerts from said plurality of attendance modules; and
each said plurality of attendance modules includes a clock and a touchscreen display, wherein at least one of a fingerprint sensor and an ID reader, and further wherein said central hub receives alerts from said plurality of attendance modules and transmits said alerts to at least another electronic device.

2. The attendance monitoring and notification system of claim 1, wherein said transmitting said alert includes transmitting to a remote key fob.

3. The attendance monitoring and notification system of claim 1, wherein said alert includes a student ID, a student location, and an in-time of a student.

4. The attendance monitoring and notification system of claim 3, wherein said alert includes an out-time of said student.

5. A method for tracking and monitoring a location of a student throughout the day, the method comprising the steps of:
receiving a student information through an attendance module;
timestamping an in-time of the student through a clock integral with said attendance module;
displaying said student information, a location of said attendance module, and said in-time; and
transmitting said student information, said location of said attendance module, and said in-time to an associated remote electronic device.

6. The method of claim 5, wherein said receiving said student information includes a fingerprint image.

7. The method of claim 5, wherein said receiving said student information includes an ID reader.

8. The method of claim 5 further comprising a step of timestamping an out-time of said student through a clock integral with said attendance module, and a step of displaying said student information, said location of said attendance module, and said out-time.

9. The method of claim 8 further comprising a step of transmitting said student information, said location of said attendance module, and said out-time to said associated remote electronic device.

10. The method of claim 9, wherein said associated remote electronic device is a key fob.

11. The method of claim 7 further comprising a step of recording a video of the student at said attendance module.

12. The method of claim 5, wherein said attendance module includes a touchscreen display.

13. A method for tracking and monitoring a location of an individual, the method comprising the steps of:
receiving individual location information through a plurality of attendance modules;
timestamping a first in-time of said individual through a first clock integral with a first attendance module;
displaying said individual information, a location of said first attendance module, and said first in-time;
transmitting said individual information, said location of said first attendance module, and said first in-time to an associated remote electronic device;
timestamping a first out-time of said individual through said clock integral with said first attendance module;
displaying said individual information, said location of said first attendance module, and said first out-time;
transmitting said individual information, said location of said first attendance module, and said first out-time to said associated remote electronic device;
timestamping a second in-time of said individual through a second clock integral with a second attendance module;
displaying said individual information, a location of said second attendance module, and said second in-time; and
transmitting said individual information, said location of said second attendance module, and said second in-time to said associated remote electronic device.

14. The method of claim 13, wherein said receiving said individual information includes a fingerprint image.

15. The method of claim 13, wherein said receiving said individual information includes an ID reader.

16. The method of claim 13, wherein said associated remote electronic device is a key fob.

17. The method of claim 13 further comprising a step of recording a first video of said individual at said first attendance module.

18. The method of claim 13, wherein said first attendance module includes a first touchscreen display.

19. The method of claim 17 further comprising a step of recording a second video of said individual at said second attendance module.

20. The method of claim 18, wherein said second attendance module includes a second touchscreen display.
